(19) United States
(12) Patent Application Publication
(10) Pub. No.: US 2025/0098717 A1
(43) Pub. Date: Mar. 27, 2025

(54) TABLET

(71) Applicant: TOYO SHINYAKU CO., LTD., Fukuoka-shi (JP)

(72) Inventors: Hiroya TAKAHASHI, Saga (JP); Yoshifumi Koseki, Saga (JP)

(73) Assignee: TOYO SHINYAKU CO., LTD., Fukuoka-shi (JP)

(21) Appl. No.: 18/473,623

(22) Filed: Sep. 25, 2023

(51) Int. Cl. A23L 19/00; A23L 5/00; A23L 33/105

(52) U.S. Cl. CPC A23L 19/01; A23L 5/00; A23L 33/105

(57) ABSTRACT

A tablet includes a dark-green vegetable. The dark-green vegetable may serve as the disintegrating agent to provide a tablet with excellent disintegrability. Even if the tablet includes a substance that increases disintegration time, the dark-green vegetable may result in a lower disintegration time. A method for producing a tablet includes tableting a mixture containing a dark-green vegetable.

### BACKGROUND OF THE INVENTION

### Technical Field

The present invention relates to a tablet containing a dark-green vegetable.

### Description of Related Art

Tablets are solid preparations having advantages of easiness of taking, easiness of taking a certain amount, and easiness of transport and are widely used not only for pharmaceutical products but also for health foods. Tablets contain an active ingredient (an ingredient as the purpose for intake of the tablets), but the disintegrability of the tablets deteriorates depending on the type of the active ingredient. For example, it is known that the disintegrability of tablets becomes extremely poor when a proteoglycan-containing cartilage extract is blended (Patent Literature 1). Because the active ingredient is not easily absorbed in the body unless the tablets disintegrate after the intake, a disintegrating agent is often blended when a component which delays disintegration is blended or when an immediate effect is to be exhibited.

A disintegrating agent refers to a component which causes tablets to disintegrate easily. As the disintegrating agents, for example, sodium carboxymethyl cellulose (Patent Literature 2), low-substituted hydroxypropyl cellulose, crospovidone (Patent Literature 3), and starch (Patent Literature 4) are known. These disintegrating agents are often used mainly for pharmaceutical products.

On the other hand, disintegrating agents are not often used for health foods. This is believed based on the following reasons: many of the disintegrating agents are synthesized compounds, which makes many consumers to feel uncomfortable with their addition to foods; and the addition to foods is restricted by the low depending of the type of disintegrating agent. Although starch is known as a naturally derived disintegrating agent, health-conscious consumers do not prefer starch because it is a saccharide. Thus, development of a naturally derived disintegrating agent which contains nutrient components in abundance has been desired.

### CITATION LIST

### Patent Literature

[Patent Literature 1] JP6990589B
[Patent Literature 2] JP3310233B
[Patent Literature 3] JP4158017B
[Patent Literature 4] JPH06-88899B

### SUMMARY OF INVENTION

### Technical Problem

The present invention has been made in view of the above problems and is intended to provide a tablet containing a dark-green vegetable and having excellent disintegrability.

### Solution to Problem

The present inventors have found out, in the process of examining a disintegrating agent to be blended in tablets, that a tablet having excellent disintegrability can be obtained by blending a dark-green vegetable and thus have completed the present invention.

Specifically, the present invention is as follows.
(1) A tablet including a dark-green vegetable.
(2) The tablet according to (1), wherein the dark-green vegetable is a dry powder.
(3) The tablet according to (1) or (2), which is for a food.
(4) The tablet according to any one of (1) to (3), wherein a content of the dark-green vegetable is 1% to 60% by weight based on the tablet.
(5) The tablet according to any one of (1) to (3), wherein a content of the dark-green vegetable is 20% to 60% by weight based on the tablet.
(6) The tablet according to any one of (1) to (3), wherein a content of the dark-green vegetable is 30% to 60% by weight based on the tablet.
(7) The tablet according to any one of (2) to (6), wherein the dry powder of the dark-green vegetable is a crushed powder or a juice powder of the dark-green vegetable.
(8) The tablet according to any one of (1) to (7), wherein the dark-green vegetable is a green leaf of at least one plant selected from oats, kale, ocarina, mulberry, Angelica keiskei, wormwood, Peucedanum japonicum, Kuma Bamboo Grass, spinach, Swiss chard, and celery.
(9) The tablet according to any one of (1) to (8), wherein the dark-green vegetable is young barley grass.
(10) The tablet according to any one of (1) to (9), further including a component that delays disintegration of the tablet.
(11) The tablet according to any one of (1) to (10), further including a proteoglycan-containing cartilage extract.
(12) The tablet according to any one of (1) to (11), having a disintegration time of 120 minutes or less.
(13) The tablet according to any one of (1) to (12), further including a component that delays disintegration of the tablet, wherein the tablet has a disintegration time of 120 minutes or less.
(14) A method for producing a tablet, including tableting a mixture containing a dark-green vegetable.
(15) A method for improving the disintegrability of a tablet by blending a dark-green vegetable.

### Advantageous Effects of Invention

According to the present invention, by blending a dark-green vegetable in a tablet, a tablet having excellent disintegrability can be provided.

### DETAILED DESCRIPTION OF EMBODIMENTS

The present disclosure is explained in detail in the following.

### [1. Dark-Green Vegetables]

The dark-green vegetables of the present disclosure relate to vegetables having green color, specifically include green leaves of plants such as oats, kale, ocarina, mulberry, Angelica keiskei, wormwood, Peucedanum japonicum, Kuma Bamboo Grass, spinach, Swiss chard, celery, cabbage, colored green, lettuce, carrot, and tea, and vegetables such as pepper, goya, Japanese mustard spinach, green onion, Chinese chive, Broccoli, and peas. Parts of dark-green vegetables used in the present disclosure are not limited as long as it includes parts having green color, and for example, leaves, stem, and berries can be used.

As dark-green vegetables of the present disclosure, plants belonging to any family can be used, and for examples plants of Granmineae, Brassicaceae, Amaranthaceae, Apiaceae, Convolvulaceae, Moraceae, Asteraceae, and Chenopodiaceae can be used. From the viewpoint of having excellent disintegrability, and the viewpoint of comprising nutrient components in abundance, plants of Granmineae, Brassicaceae, Amaranthaceae, Apiaceae are more preferable, plants of Granmineae, Brassicaceae, Amaranthaceae are particularly preferable, and plants of Granmineae are most preferable.

As dark-green vegetables of the present disclosure, plants belonging to any genus can be used, and for examples plants of Granmineae Hordeum, Granmineae Sasa, Brassicaceae Brassica, Amaranthaceae Spinacia, Apiaceae Angelica, Apiaceae Peucedanum, Apiaceae Apium, Convolvulaceae Ipomoea, Moraceae Morus, Asteraceae Artemisia, Chenopodiaceae Beta, etc. can be used. From the viewpoint of having particularly excellent disintegrability, and the viewpoint of comprising nutrient components in abundance, plants of Granmineae Hordeum, Granmineae Sasa, Brassicaceae Brassica, Amaranthaceae Spinacia are more preferable, plants of Granmineae Hordeum, Granmineae Sasa, Brassicaceae Brassica, Amaranthaceae Spinacia are more preferable, and plants of Granmineae Hordeum are most preferable.

### [2. Green Leaves of Specific Plant]

As dark-green vegetables of the present disclosure, any dark-green vegetables can be used. However, from the viewpoint of having particularly excellent disintegrability, and the viewpoint of comprising nutrient components in abundance, it is particularly preferable to use green leaves of specific plants as described in the following as dark-green vegetables. Specific plants of the present disclosure mean at least one plant selected from oats, kale, ocarina, mulberry, Angelica keiskei, wormwood, Peucedanum japonicum, Kuma Bamboo Grass, spinach, Swiss chard and celery. Only one type can be used, but two or more types can be also used. From the viewpoint of having particularly excellent disintegrability, and the viewpoint of comprising nutrient components in abundance, among green leaves of specific plants, green leaves of oats are particularly preferable, and green leaves of barley (young barley grass) are most preferable.

Green leaves of specific plants of the present disclosure relate to plant body including leaf part of the specific plant, and can include leaves, as well as stem, or other parts. Since it takes effort to remove stem from the aerial part at the time of harvest, and the stem part also comprises nutrient components such as insoluble dietary fiber, etc. in abundance, from the viewpoint of reducing manufacturing cost and the viewpoint of ability, it is preferable to comprise stem together with leaves.

### <Oats>

Oats of the present disclosure mean a collective term of gramineous plant having similar appearance, such as barley, wheat, rye, oat, etc. As oats of the present disclosure, barley is particularly preferable.

Barley (Hordeum vulgare L.) is said to be native of Central Asia, is a poaceous annual or biennial grass plant belonging to Granmineae Hordeum. As barley used in the present disclosure, breed is not particularly limited. Barley of any breed can be used, and even wild species or crossbred can be used. For example, two-row barley, six-row barley, naked barley etc. can be exemplified, and these can be used by combining one or more breeds.

Green leaves of oats can be any one harvested at any harvest season, and are not particularly limited. For example, when oats are barley, it is preferable to use those harvested before mature stage, specifically those harvested from initiation of tillering stage to before initiation of ear emergence (young barley grass). Specifically, it is preferable to use young barley grass harvested from barley having a height of 10 cm or more, preferably about 10 to 90 cm, particularly preferably about 20 to 80 cm, best of all about 30 to 70 cm.

### <Kale>

Kale of the present disclosure means a plant of Brassicaceae Brassica, which scientific name is Brassica oleracea var. acephala. Breed of kale is not particularly limited, and various types of kale such as Kitchen Kale, Tree Kale, Bush Kale, Marrow Kale, Collard, Green leaf kale, etc. can be used. Green leaves of kale can be any one harvested at any harvest season, and are not particularly limited.

### <Ocarina>

Ocarina of the present disclosure means a plant of Convolvulaceae Ipomoea, which scientific name is Ipomea batatas. Ocarina is not particularly limited as long as it is one generally called sweet potato. Breed of ocarina is not particularly limited, and for example, breeds such as Suio, Joy White, Kogane-sengan, Shiroyutaka, Satsuma starch, Ayamurasaki can be exemplified. Among these, Suio having a high polyphenol content is preferable.

Green leaves of ocarina can be any one harvested at any harvest season, and are not particularly limited. Tip part of stem and leaf (young stem and leaf) is preferable, and young stem and leaf in a state maintaining yellow-tinged green color is further preferable.

### <Mulberry>

Mulberry of the present disclosure means a plant of Moraceae Morus (genus Morus). Species of mulberry are not particularly limited, and Morus alba, Morus Australia, Morus lhou, Morus laevigata, Morus tiliaefolia, Morus boninensis, Morus serrata, etc. can be used. Green leaves of mulberry can be any one harvested at any harvest season, and are not particularly limited.

<Angelica keiskei>

Angelica keiskei of the present disclosure means a plant of Apiaceae Angelica. Breed of Angelica keiskei is not particularly limited and can be appropriately used. Green leaves of Angelica keiskei can be any one harvested at any harvest season, and are not particularly limited.

### <Wormwood>

Wormwood of the present disclosure means perennial plant of Asteraceae Artemisia (genus Artemisia). Species of wormwood are not particularly limited, and Artemisia indica, Artemisia absinthium, Artemisia dracunculus, Nitrof wormwood, Artemisia congesta, Artemisia capillaris, Artemisia japonica, Artemisia scoparia, Artemisia apiacea, Artemisia annua, Artemisia keshkeana, Artemisia pedenculosa, Artemisia trifucata, Artemisia arctica, Artemisia sinanensis, Artemisia glomerata, Artemisia lacinata, Artemisia stelleriana, Artemisia iwayomogi, Artemisia feddei, Artemisia gilvescens, Artemisia dubia, Artemisia monophylla, Artemisia unalaskensis, Artemisia koidzumii, Artemisia stolonifera, Artemisia momiyamae, Artemisia ruburipes, Artemisia montana, Artemisia indica, Artemisia schmidtiana, Artemisia kitadakensis, etc. can be used. Among these, Artemisia indica is particularly preferable. Green leaves of Artemisia indica can be any one harvested at any harvest season, and are not particularly limited.

<Peucedanum japonicum>

Peucedanum japonicum of the present disclosure means a plant of Apiaceae Pternopetalum. Peucedanum is called Danboufu, Chomeiso, Chomeigusa, Chomifusa, Bofu, Sakuna, Ububasafuna, Chomigusa, Botanbofu depending on the region. Breed of Peucedanum japonicum is not particularly limited, and can be appropriately used. Green leaves of Peucedanum japonicum can be any one harvested at any harvest season, and are not particularly limited.

### <Kuma Bamboo Grass>

Kuma Bamboo Grass of the present disclosure means a plant of Sasa beitchii (genus Sasa). Species of Kuma Bamboo Grass are not particularly limited, and Sasa veitchii, Sasa kurilensis, Sasamorpha borealis, Sasa senanensis, Sasa palmata, Sasa niponica, etc. can be used. Green leaves of Kuma Bamboo Grass can be any one harvested at any harvest season, and are not particularly limited.

### <Spinach>

Spinach of the present disclosure means a plant of Amaranthaceae Spinacia, which scientific name is Spinacia oleracea. Breed of spinach is not particularly limited, and can be appropriately used. Green leaves of spinach can be any one harvested at any harvest season, and are not particularly limited.

### <Swiss Chard>

Swiss chard of the present disclosure means a plant of Chenopodiaceae Beta, which scientific name is Beta vulgaris. In Japan, it is also called Fudanso. Breed of Swiss chard is not particularly limited, and can be appropriately used. Green leaves of Swiss chard can be any one harvested at any harvest season, and are not particularly limited.

### <Celery>

Celery of the present disclosure means a plant of Apiaceae Apium, which scientific name is Apium graveolens. Breed of celery is not particularly limited, and can be appropriately used. Green leaves of celery can be any one harvested at any harvest season, and are not particularly limited.

### [3. Dry Powder of Dark-Green Vegetables]

As dark-green vegetables used for the tablet of the present disclosure, for example, dry powder of dark-green vegetables can be used. Dry powder of dark-green vegetable of the present disclosure means those made by processing dark-green vegetables and dried and powderized. Examples of dry powder of dark-green vegetables include those made by crushing dark-green vegetables and dried and powderized (crushed powder of dark-green vegetables), those made by drying and powderizing juice of dark-green vegetables (juice powder of dark-green vegetables), and those made by drying and powderizing extract of dark-green vegetables (extract powder of dark-green vegetables), but it is not limited to these. As dry powder of dark-green vegetables of the present disclosure, it is preferable to be crushed powder of dark-green vegetables from the viewpoint of having excellent disintegrability, the viewpoint of easiness of processing, storage, transport, etc. and the viewpoint of comprising dietary fiber in abundance.

As crushed powder of dark-green vegetables of the present disclosure, those obtained for example by combining drying treatment and crushing treatment can be used. Drying treatment and crushing treatment can be performed at the same time, or either one can be performed before the other one. However, it is preferable to first perform drying treatment, and then perform crushing treatment. According to need, one or more treatments selected from treatment such as blanching treatment and disinfection treatment can be performed in combination. The number of times for performing crushing treatment is not particularly limited, and it can be performed as one or more treatments, such as after performing coarse crushing treatment, performing fine crushing for crushing more finely.

Blanching treatment is a treatment to keep the green color of dark-green vegetables of the specific plant bright, and examples of a method of blanching treatment include hot-water treatment and steaming treatment.

Examples of hot-water treatment include a method of treating dark-green vegetables in hot water or moisture of for example 70 to 100° C., preferably 80 to 100° C., for 60 to 240 sec, preferably for 90 to 180 sec. As steaming treatment, an intermittent steaming treatment of repeating a treatment of steaming dark-green vegetables with moisture and a treatment of cooling at normal pressure or under pressure is preferable.

Disinfection treatment is not particularly limited as long as it is a disinfection treatment commonly known to a person skilled in the art. For example, it can be a treatment of killing microorganisms physically or chemically by using temperature, pressure, electromagnetic wave, drugs, etc.

When performing blanching treatment additionally to drying treatment and crushing treatment, it is preferable that blanching treatment is performed before drying treatment. Further, when performing disinfection treatment additionally to drying treatment and crushing treatment, it is preferable that disinfection treatment is performed after drying treatment, or before or after crushing treatment.

Drying treatment is not particularly limited, but examples include treatment of drying so that the water content of dark-green vegetables becomes 10% by weight or less, preferably 8% by weight or less.

Crushing treatment is not particularly limited, but examples include treatment of crushing plant bodies by an arbitrary method that a person skilled in the art commonly uses. When performing crushing treatment, it is preferable to perform the treatment by combining coarse crushing and fine crushing, from the viewpoint of increasing crushing efficiency, such as to make the particle size uniform, shortening the crushing time, etc.

As juice powder of dark-green vegetables of the present disclosure, for example, those obtained by concentrating juice of dark-green vegetables at low temperature to concentrate the solid content, and lyophilizing or spray drying the concentrated liquid can be used.

### [4. Tablet Containing Dark-Green Vegetable]

The tablet of the present disclosure contains a dark-green vegetable. The lower limit of the dark-green vegetable content in the tablet is not particularly restricted but is, from the viewpoint of having especially excellent disintegrability and from the viewpoint of containing nutrient components in abundance, preferably 1% by weight or more, more preferably 3% by weight or more, further preferably 5% by weight or more, still further preferably 15% by weight or more, especially preferably 20% by weight or more, particularly preferably 25% by weight or more, and most preferably 30% by weight or more. The upper limit of the dark-green vegetable content in the tablet is not particularly restricted but is, from the viewpoint of blending an excipient for enhancing the strength of the tablet, preferably 60% by weight or less.

The weight of the tablet of the present disclosure per one tablet is not particularly restricted but is, from the viewpoint of easiness of intake, preferably 100 to 500 mg per one tablet, and particularly preferably 150 to 400 mg.

Because the tablet of the present disclosure exhibits good disintegrability even when the tablet contains a component which delays disintegration, the tablet of the present disclosure is preferable when a component which delays disintegration is blended. As a component which delays disintegration, for example, a proteoglycan-containing cartilage extract may be contained. Proteoglycans are sugar proteins in which a sugar chain called a glycosaminoglycan, such as chondroitin sulfate, is covalently attached to a core protein. Proteoglycans has a joint function-improving action or a lipid metabolism-improving action and thus draw attention as functional components of health foods.

A fluidity-improving agent is preferably blended in the tablet of the present disclosure from the viewpoint of improving the producibility. An example of the fluidity-improving agent is silicon dioxide. The silicon dioxide content in the tablet is preferably 0.1 to 2% by weight, and particularly preferably 0.3 to 1% by weight.

A lubricant is preferably blended in the tablet of the present disclosure from the viewpoint of improving the producibility (preventing sticking during tableting). An example of the lubricant is calcium stearate. The calcium stearate content in the tablet is preferably 0.1 to 3% by weight, and particularly preferably 0.5 to 2% by weight.

A component other than those described above can also be appropriately blended in the tablet of the present disclosure. For example, an excipient, a binding agent, an aroma or the like may be blended in the tablet of the present disclosure.

The disintegration time of the tablet of the present disclosure is not particularly restricted but is, for example, preferably 120 minutes or less, more preferably 80 minutes or less, and most preferably 60 minutes or less. Here, the disintegration time of the tablet can be measured according to the Japanese Pharmacopoeia, 15th Edition (Mar. 31, 2006, Ministerial Notification No. 285 of Ministry of Health, Labour and Welfare) shown below.

The tablet of the present disclosure can also be used for bath products or the like but is preferably used for oral use such as pharmaceutical products and foods because the tablet contains nutrient components in abundance. Moreover, a dark-green vegetable is used as the disintegrating agent in the present disclosure, and a consumer can take the dark-green vegetable without feeling uncomfortable because the dark-green vegetable is a natural component containing nutrient components in abundance. Thus, the tablet is particularly preferably used as a tablet for a food.

### Examples

In the following, the present invention is explained in detail with the Examples. However, the present invention is not limited to these Examples, and as long as the problems of the present invention can be solved, the present invention can have various embodiments.

### [1. Assessment of Disintegration Actions of Dark-Green Vegetables]

To assess the disintegration actions of dark-green vegetables, a test for comparing the disintegration actions of starch, which is a common disintegrating agent, and dark-green vegetables was conducted.

### (Production of Tablets)

Raw materials were mixed as shown in Table 1 and then tableted using a rotary tableting machine, and tablets weighing 400 mg per one tablet were produced. As the proteoglycan-containing cartilage extract, a porcine cartilage extract containing 20% by weight of proteoglycan (mucopolysaccharide protein) was used.

### (Measurement of Disintegration Times)

According to the Japanese Pharmacopoeia, 15th Edition (Mar. 31, 2006, Ministerial Notification No. 285 of Ministry of Health, Labour and Welfare), the disintegration times required until the tablets disintegrated were measured using a disintegration tester (model: NT-40H, manufactured by Toyama Sangyo Co., Ltd.). The measurement results are shown in Table 1. Here, the “disintegration of a tablet” was determined according to the definitions of the Japanese Pharmacopoeia, 15th Edition. Definitions of “Disintegration of Tablets”

When no residue of the sample is observed at all, or when the residue, if any, is a soft material clearly without the original form or is a fragment of the agent coating, the tablet is considered to have disintegrated.

TABLE 1

| | | | Comparative | Reference |
|---|---|---|---|---|
| | Example 1 | Example 2 | Example 1 | Example 1 |
| Glucosamine | 46.9 | 46.9 | 46.9 | 46.9 |
| Starch | 16.6 | 16.6 | 16.6 | 21.6 |
| Cellulose | 15 | 15 | 15 | 15 |
| Cockscomb Extract | 5 | 5 | 5 | 5 |
| Proteoglycan- | 10 | 10 | 10 | 10 |
| Containing Cartilage | | | | |
| Extract | | | | |
| Crushed Powder of | 5 | | | |
| Young Barley Grass | | | | |
| Crushed Powder of | | 5 | | |
| Kale | | | | |
| Crushed Powder of | | | 5 | |
| Pumpkin | | | | |
| Calcium Stearate | 1 | 1 | 1 | 1 |
| Silicon Dioxide | 0.5 | 0.5 | 0.5 | 0.5 |
| Total | 100 | 100 | 100 | 100 |
| Disintegration Time | 818 | 1176 | 1636 | 1151 |
| (second) | | | | |

### Results

Example 1, Example 2, and Comparative Example 1 are tablets in which 5% by weight of the starch in Reference Example 1 was replaced with 5% by weight of crushed powder of young barley grass, crushed powder of kale, and crushed powder of pumpkin, respectively. When the disintegration times were compared, the disintegration time of Example 1 was shorter than that of Reference Example 1, and the disintegration time of Example 2 was comparable to that of Reference Example 1. From the results, it was found that young barley grass and kale have the same or better disintegration action as that of starch, which is a common disintegrating agent.

### [2. Influence of Dark-Green Vegetable Content on Disintegration Action]

To assess the influence of the dark-green vegetable content on the disintegration action, a test for producing tablets having different dark-green vegetable contents and comparing their disintegration times was conducted.

### (Production of Tablets)

Raw materials were mixed as shown in Table 2 and then tableted using a rotary tableting machine, and tablets weighing 150 mg per one tablet were produced.

### (Comparison of Disintegration Times)

The disintegration times were measured in the same manner as in the method described above, and the shortening rates of the disintegration time based on that of Reference Example 2 were calculated by the following equation. The results are shown in Table 2.

$$Shortening Rate ( \% ) of Disintegration Time = ( Disintegration Time of Reference Example 2 - Disintegration Time of Tablet ) / Disintegration Time of Reference Example 2 \times 100$$

TABLE 2

| | Reference | | | | | | | |
|---|---|---|---|---|---|---|---|---|
| | Example 2 | Example 3 | Example 4 | Example 5 | Example 6 | Example 7 | Example 8 | Example 10 |
| Crushed Powder of | | 1 | 3 | 15 | 20 | 25 | 30 | 60 |
| Young Barley Grass | | | | | | | | |
| Starch | 60 | 59 | 57 | 45 | 40 | 35 | 30 | |
| Calcium Stearate | 1 | 1 | 1 | 1 | 1 | 1 | 1 | 1 |
| Silicon Dioxide | 2 | 2 | 2 | 2 | 2 | 2 | 2 | 2 |
| Hydroxypropyl Cellulose | 10 | 10 | 10 | 10 | 10 | 10 | 10 | 10 |
| Maltose | 27 | 27 | 27 | 27 | 27 | 27 | 27 | 27 |
| Total | 100 | 100 | 100 | 100 | 100 | 100 | 100 | 100 |
| Shortening Rate of | — | 25% | 26% | 26% | 43% | 53% | 86% | 91% |
| Disintegration Time | | | | | | | | |

### Results

Examples 3 to 10 are tablets in which a part of the starch in Reference Example 2 was replaced with the same amount of crushed powder of young barley grass. By merely replacing 1% by weight of the starch with the crushed powder of young barley grass, the disintegration time could be shortened by 25% (Example 3). Moreover, there was a tendency towards shorter disintegration time as the weight of the replacing crushed powder of young barley grass was higher (Examples 3 to 10).

### [3. Production of Tablets Containing Dark-Green Vegetables]

Raw materials were mixed as shown in Table 3 and then tableted using a rotary tableting machine, and tablets weighing 300 mg per one tablet were produced. The tablets of Examples 11 to 22 all had excellent disintegrability.

TABLE 3

| | Example | | | | | | | | | | | |
|---|---|---|---|---|---|---|---|---|---|---|---|---|
| | 11 | 12 | 13 | 14 | 15 | 16 | 17 | 18 | 19 | 20 | 21 | 22 |
| Crushed Powder of | 5 | | | | | | | | | | | |
| Young Barley Grass | | | | | | | | | | | | |
| Juice Powder of Young | | 5 | | | | | | | | | | |
| Barley Grass | | | | | | | | | | | | |
| Crushed Powder of | | | 5 | | | | | | | | | |
| Kale | | | | | | | | | | | | |
| Crushed Powder of | | | | 5 | | | | | | | | |
| Young Ocarina Leaves | | | | | | | | | | | | |
| Crushed Powder of | | | | | 5 | | | | | | | |
| Mulberry Leaves | | | | | | | | | | | | |
| Crushed Powder of | | | | | | 5 | | | | | | |
| Angelica keiskei | | | | | | | | | | | | |
| Crushed Powder of | | | | | | | 5 | | | | | |
| Wormwood Leaves | | | | | | | | | | | | |
| Crushed Powder of | | | | | | | | 5 | | | | |
| Peucedanum japonicum | | | | | | | | | | | | |
| Crushed Powder of | | | | | | | | | 5 | | | |
| Kuma Bamboo Grass | | | | | | | | | | | | |
| Crushed Powder of | | | | | | | | | | 5 | | |
| Spinach | | | | | | | | | | | | |
| Crushed Powder of | | | | | | | | | | | 5 | |
| Swiss Chard | | | | | | | | | | | | |
| Crushed Powder of | | | | | | | | | | | | 5 |
| Celery | | | | | | | | | | | | |
| Cellulose | 20 | 20 | 20 | 20 | 20 | 20 | 20 | 20 | 20 | 20 | 20 | 20 |
| Maltose | 74 | 74 | 74 | 74 | 74 | 74 | 74 | 74 | 74 | 74 | 74 | 74 |
| Silicon Dioxide | 0.5 | 0.5 | 0.5 | 0.5 | 0.5 | 0.5 | 0.5 | 0.5 | 0.5 | 0.5 | 0.5 | 0.5 |
| Calcium Stearate | 1 | 1 | 1 | 1 | 1 | 1 | 1 | 1 | 1 | 1 | 1 | 1 |
| Total | 100 | 100 | 100 | 100 | 100 | 100 | 100 | 100 | 100 | 100 | 100 | 100 |

### INDUSTRIAL APPLICABILITY

The tablet of the present invention contains a dark-green vegetable which contains nutrient components in abundance and has excellent disintegrability, and the tablet can be thus used as a pharmaceutical product or a food. Thus, its industrial applicability is high.

What is claimed is:

1. A tablet comprising a dark-green vegetable.

2. The tablet according to claim 1, wherein the dark-green vegetable is a dry powder.

3. The tablet according to claim 1 which is for a food.

4. The tablet according to claim 1, wherein a content of the dark-green vegetable is 1% to 60% by weight based on the tablet.

5. The tablet according to claim 1, wherein a content of the dark-green vegetable is 20% to 60% by weight based on the tablet.

6. The tablet according to claim 1, wherein a content of the dark-green vegetable is 30% to 60% by weight based on the tablet.

7. The tablet according to claim 2, wherein the dry powder of the dark-green vegetable is a crushed powder or a juice powder of the dark-green vegetable.

8. The tablet according to claim 1, wherein the dark-green vegetable is a green leaf of at least one plant selected from oats, kale, ocarina, mulberry, Angelica keiskei, wormwood, Peucedanum japonicum, Kuma Bamboo Grass, spinach, Swiss chard, and celery.

9. The tablet according to claim 1, wherein the dark-green vegetable is young barley grass.

10. The tablet according to claim 1, further comprising a component that delays disintegration of the tablet.

11. The tablet according to claim 1, further comprising a proteoglycan-containing cartilage extract.

12. The tablet according to claim 1, having a disintegration time of 120 minutes or less.

13. The tablet according to claim 1, further comprising a component that delays disintegration of the tablet, wherein the tablet has a disintegration time of 120 minutes or less.

14. A method for producing a tablet, comprising tableting a mixture containing a dark-green vegetable.
